(19) United States
(12) Patent Application Publication
(10) Pub. No.: US 2019/0086575 A1
(43) Pub. Date: Mar. 21, 2019

(54) Real-Time Self-Consistency Quality Indicators for Multi-Component Induction Tools

(71) Applicant: Halliburton Energy Services, Inc., Houston, TX (US)

(72) Inventors: Ahmed Elsayed Fouda, Houston, TX (US); Burkay Donderici, Houston, TX (US); Junsheng Hou, Kingwood, TX (US)

(73) Assignee: Halliburton Energy Services, Inc., Houston, TX (US)

(21) Appl. No.: 16/061,636

(22) PCT Filed: Jun. 30, 2017
(86) PCT No.: PCT/US2017/040489

§ 371 Date: Jun. 12, 2018

Related U.S. Application Data
(60) Provisional application No. 62/357,813, filed on Jul. 1, 2016.

(51) Int. Cl. G01V 3/28; G01V 3/12; G01V 3/30; G01V 3/38; E21B 49/00; E21B 47/12

(52) U.S. Cl. CPC G01V 3/28; G01V 3/12; E21B 47/12; G01V 3/38; E21B 49/00; G01V 3/30

(57) ABSTRACT

According to at least some embodiments, a method of processing inversion results corresponding to a plurality of parameters of a subterranean formation includes obtaining measurements of the subterranean formation from a multi-component induction (MCI) tool. The method further includes inverting the measurements to determine a first estimated value of a parameter of the plurality of parameters. The method further includes determining at least a second estimated value of the parameter, and assessing a quality of the inverted measurements by comparing the first estimated value with the at least a second estimated value.

### CROSS-REFERENCE TO RELATED APPLICATION(S)

This application claims the benefit of U.S. Provisional Application No. 62/357,813, filed Jul. 1, 2016, the contents of which are incorporated by reference herein in their entirety.

### BACKGROUND

In the oil and gas industry, resistivity logging tools are frequently used to measure the electrical resistivity of rock formations surrounding an earth borehole. Such information regarding resistivity is useful in ascertaining the presence or absence of hydrocarbons. A typical resistivity logging tool includes a transmitter antenna and two or more receiver antennas located at different distances from the transmitter antenna along the axis of the tool. The transmitter antenna is used to create electromagnetic fields in the surrounding formation. In turn, the electromagnetic fields in the formation induce an electrical voltage in each receiver antenna. Due to geometric spreading and absorption by the surrounding earth formation, the induced voltages in the various receiving antennas have different phases and amplitudes. The depth of investigation (as defined by a radial distance from the tool axis) to which such a resistivity measurement pertains is a function of the frequency of the transmitter antenna and the distance from the transmitter to the receiver antennas. Thus, one may achieve multiple radial depths of investigation of resistivity either by providing multiple receiver antennas at different distances from the transmitter or by operating at multiple frequencies.

Many formations are electrically anisotropic, a property which is generally attributable to fine layering during the sedimentary build-up of the formation. Hence, in a formation coordinate system oriented such that the x-y plane is parallel to the formation layers and the z axis is perpendicular to the formation layers, resistivities Rₓ and R_{y} in directions x and y, respectively, are the same for transversely isotropic (TI) formations, but resistivity R_{z} in the z direction is different from Rₓ and R_{y}. Thus, the resistivity in a direction parallel to the plane of the formation (i.e., the x-y plane) is known as the horizontal resistivity, Rₕ, and the resistivity in the direction perpendicular to the plane of the formation (i.e., the z direction) is known as the vertical resistivity, Rᵥ. The anisotropy coefficient, λ, is defined as λ=[Rᵥ/Rₕ]^{1/2}. In some formations, the resistivity in the x direction is different from that in the y direction. These are known as biaxially anisotropic (BA) formations.

The relative dip angle or relative dip, θ, based on the logging tool is the angle between the tool axis and the normal to the formation layering. The resistive anisotropy and the relative dip each has effects on resistivity logging tool measurements. As a result, resistivity logging systems attempt to model and account for the anisotropy and relative dip, but the various methods for approaching this issue achieve different levels of success in different environments, creating undesirable uncertainty.

### BRIEF DESCRIPTION OF THE DRAWINGS

There are disclosed in the drawings and the following description various systems and methods for assessing the quality of inverted parameters that are based on measurements by a multi-component induction (MCI) tool. In the drawings:

FIG. 1 is a contextual view of an illustrative logging while drilling (LWD) environment.

FIG. 2 is a contextual view of an illustrative wireline environment.

FIG. 3 illustrates a model for inversion of various parameters (e.g., horizontal and vertical resistivities, dip, and dip azimuth) according to at least some embodiments.

FIG. 4 is a flowchart of an illustrative method that uses a quality indicator to check for consistency between radial 1-dimensional (R1D) based inversion results and borehole correction (BHC) results according to at least some embodiments.

FIG. 5 is a graph that illustrates the skin effect in different MCI arrays at a particular frequency (12 kHz).

FIG. 6 is a flowchart of an illustrative method of compensating for the conductive shoulder bed effect according to at least some embodiments.

FIG. 7 is a flowchart of an illustrative method of compensating for the conductive shoulder bed effect according to at least some embodiments.

FIGS. 8A, 8B and 8C are plots of, respectively, a shoulder bed effect presence indicator according to the method of FIG. 6, corresponding upper bounds for Rₕ, and corresponding values of the quality indicator (QI).

FIGS. 8D, 8E and 8F are plots of, respectively, a shoulder bed effect presence indicator according to the method of FIG. 7, corresponding upper bounds for Rh, and corresponding values of the QI.

FIG. 9 is a flowchart of an illustrative method that uses a QI to check for consistency between R1D and 0D inversion results according to at least some embodiments.

FIG. 10 illustrates an example of a semi-analytical forward model for homogeneous formations with biaxial anisotropy.

FIGS. 11A to 11N show examples of the application of quality indicators described with reference to various embodiments.

FIG. 12 is a flowchart of an illustrative method of processing inversion results corresponding to a plurality of parameters of a subterranean formation, according to at least one embodiment.

It should be understood, however, that the specific embodiments given in the drawings and detailed description do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

Multi-component induction (MCI) or tri-axial induction logging is used for delivering formation resistivity anisotropy (horizontal and vertical resistivities), dip, and dip azimuth (or strike). The formation resistivity anisotropy (horizontal and vertical resistivities), dip, and dip azimuth are obtained by inverting the MCI measurements (apparent conductivity tensors). MCI may not directly measure all above formation properties.

Particular embodiments relate to processing inversion results corresponding to a plurality of parameters of a subterranean formation. In at least some embodiments, a method includes obtaining measurements of the subterranean formation from the MCI tool, and invert the measurements to determine a first estimated value of a parameter of the plurality of parameters. The method further includes determining at least a second estimated value of the parameter, and assessing a quality of the inverted measurements by comparing the first estimated value with the at least a second estimated value.

A related system for logging a subterranean formation includes an MCI tool disposed in a borehole formed in the subterranean formation and a processor coupled to the MCI tool, to obtain measurements of the subterranean formation from an MCI tool, and invert the measurements to determine a first estimated value of a parameter of the plurality of parameters. The processor further determines at least a second estimated value of the parameter, and assesses a quality of the inverted measurements by comparing the first estimated value with the at least a second estimated value.

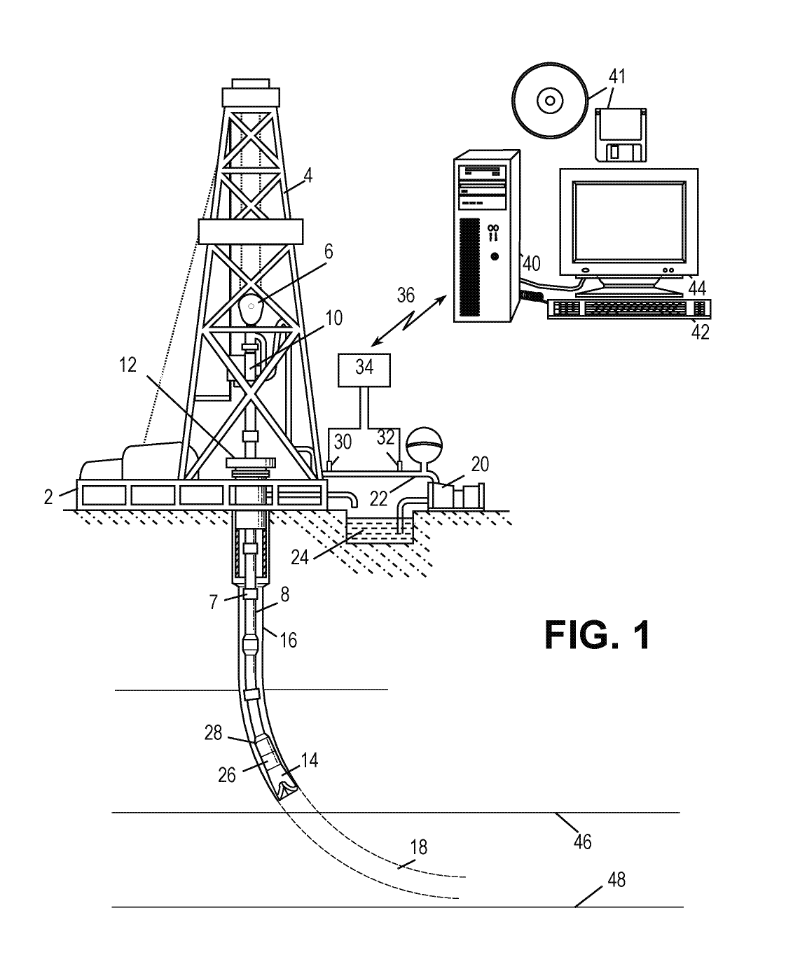

Systems and methods disclosed herein may be best understood in terms of an illustrative context in which they are employed. FIG. 1 is a contextual view of an illustrative logging while drilling (LWD) environment. FIG. 1 depicts a drilling platform 2 supporting a derrick 4 having a traveling block 6 for raising and lowering a drill string 8. A top drive 10 supports and rotates the drill string 8 as it is lowered through a wellhead 12. A drill bit 14 is driven by a downhole motor and/or rotation of the drill string 8. As the drill bit 14 rotates, it creates a borehole 16 that passes through various formations. The drill bit 14 is one piece of a bottom-hole assembly that typically includes one or more drill collars 7 (thick-walled steel pipe) to provide weight and rigidity to aid the drilling process. Some of these drill collars may include logging instruments to gather measurements of various drilling parameters such as position, orientation, weight-on-bit, borehole diameter, resistivity, etc. Resistivity can be measured by electromagnetic logging tools, where the transmitter and receiver antennas are typically mounted with their axes parallel to the longitudinal axis of the tool.

The system further includes a tool 26 to gather measurements of formation properties. Using these measurements in combination with the tool orientation measurements, the driller can steer the drill bit 14 along a desired path 18 relative to formation boundaries 46, 48 using any one of various suitable directional drilling systems including steering vanes, a “bent sub,” and a rotary steerable system. A pump 20 circulates drilling fluid through a feed pipe 22 to top drive 10, downhole through the interior of drill string 8, through orifices in drill bit 14, back to the surface via the annulus around drill string 8, and into a retention pit 24. The drilling fluid transports cuttings from the borehole into the pit 24 and aids in maintaining the borehole integrity. Moreover, a telemetry sub 28 coupled to the downhole tools 26 can transmit telemetry data to the surface via mud pulse telemetry. A transmitter in the telemetry sub 28 modulates a resistance to drilling fluid flow to generate pressure pulses that propagate along the fluid stream at the speed of sound to the surface.

One or more pressure transducers 30, 32 convert the pressure signal into electrical signal(s) for a signal digitizer 34. Note that other forms of telemetry exist and may be used to communicate signals from downhole to the digitizer 34. Such telemetry may employ acoustic telemetry, electromagnetic telemetry, or telemetry via wired drill pipe. The digitizer 34 supplies a digital form of the pressure signals via a communications link 36 to a computer 40 or some other form of a data processing device. The communications link 36 may be wired or wireless.

Computer 40 operates in accordance with software (which may be stored on information storage media 41) and user input via an input device 42 to process and decode the received signals. The software may include instructions that, when executed by a processor coupled with memory, cause the processor to perform a process (or processes) described in more detail herein. The resulting telemetry data may be further analyzed and processed by the computer 40 to generate a display of useful information on a computer monitor 44 or some other form of a display device. As shown in FIG. 1, a processing system including the computer 40 is external to the downhole tool 26, but in at least some embodiments the processing system (or at least a portion thereof) is internal to the downhole tool 26. For example, a downhole tool such as an MCI tool may include a processor, coupled with memory, that performs a process (of at least a portion thereof) described herein.

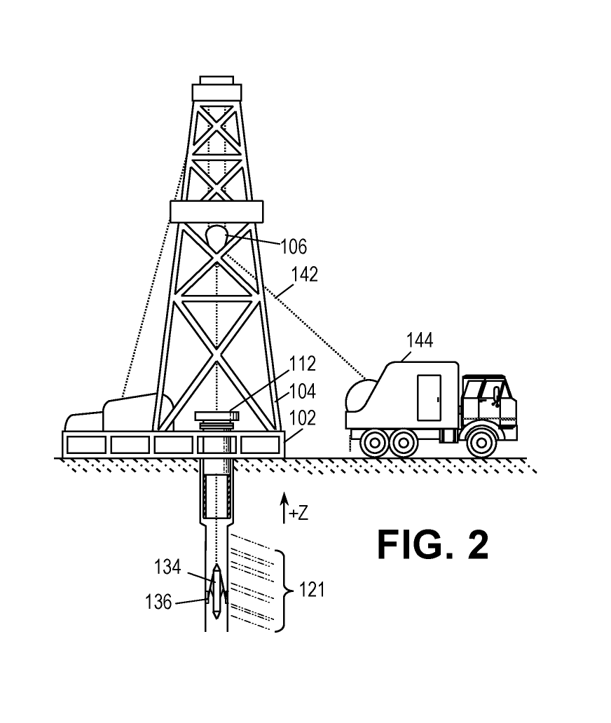

FIG. 2 is a contextual view of an illustrative wireline environment. With reference to FIG. 2, a drilling platform 102 is equipped with a derrick 104 that supports a hoist 106. At various times during the drilling process, the drill string is removed from the borehole. Once the drill string has been removed, logging operations can be conducted using a wireline logging tool 134, i.e., a sensing instrument sonde suspended by a cable 142, run through the rotary table 112, having conductors for transporting power to the tool and telemetry from the tool to the surface. An MCI logging portion of the logging tool 134 may have centralizing arms 136 that center the tool within the borehole as the tool is pulled uphole. A logging facility 144 collects measurements from the logging tool 134, and includes a processing system for processing and storing the measurements 121 gathered by the logging tool from the formation. It is understood that the processing system (or at least a portion thereof) may be internal to the logging tool 134. Accordingly, the processing (of at least a portion thereof) may be performed downhole.

Although FIG. 2 has been described with reference to a wireline assembly, it is understood that the assembly be run on wireline, slickline, coiled tubing, a downhole tractor, drillpipe, and/or any other suitable downhole tool or device.

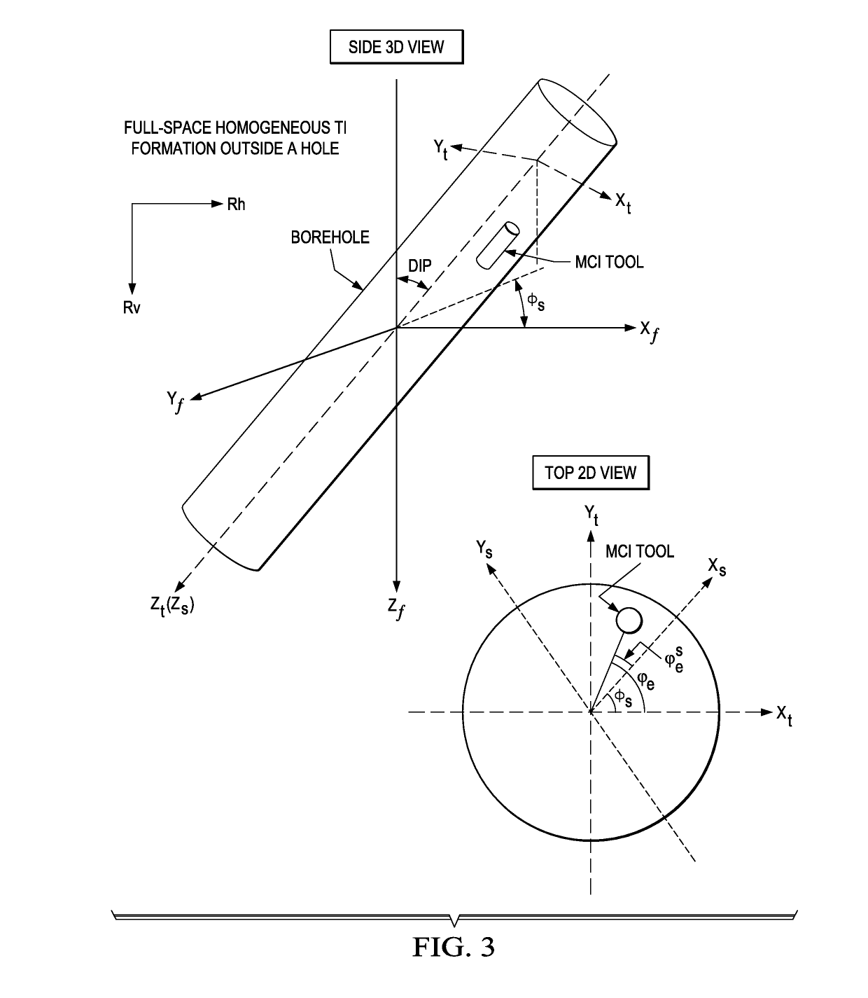

FIG. 3 illustrates a model for inversion of various parameters (e.g., horizontal and vertical resistivities, dip, and dip azimuth) according to at least some embodiments.

According to at least some embodiments, a radial 1-dimensional (R1D)-based inversion is used to perform real-time MCI processing. With reference to FIG. 3, one or more of eight unknown parameters are determined using such an inversion. Particular features will be described herein with reference to determining eight unknown parameters. However, it is understood that such features are similarly applicable to embodiments in which a subset of fewer than eight of such parameters are determined. The eight unknown parameters are expressed as an 8-dimensional column vector in Equation (1) below.

x̅=(x₁,x₂, . . . ,x₈)^{T}=(Rₕ,Rᵥ,dip,d_{ecc},φₑ,ϕₛ,Rₘ,cal)^{T} (1)

With reference to the above Equation (1), the superscript T indicates the vector transposition. Rₕ denotes formation horizontal resistivity. Rᵥ denotes formation vertical resistivity, and cal denotes the borehole diameter. Rₘ denotes borehole mud resistivity. d_{ecc} denotes tool eccentric distance (or standoff). φₑ denotes tool eccentricity azimuthal angle. dip denotes relative dip angle, and ϕₛ denotes dip azimuthal angle. In some situations, the borehole diameter and the borehole mud resistivity are supplied as inputs to inversion algorithms, if these parameters are already known or available (e.g., from other independent logs).

The R1D model of FIG. 3 may involve one or more of the following simplifications or assumptions. For example, it may be assumed that the model has infinite extension along the borehole axis. Vertical layering and shoulder bed effect may be neglected. Also, the model may assume that there is no invasion in the formation. Also, the formation may be assumed to be transversely isotropic (TI). Also, it may be assumed that the borehole (e.g., a cross-section of the borehole perpendicular to the tool axis) is circular in shape.

At every depth point, the inversion of the eight unknown parameters (including horizontal and vertical resistivities, and dip) may be expressed as the constrained nonlinear least-squares optimization problem of Equation (2) below.

$${min}_{\overline{x}} O ( \overline{x} ) = {min}_{\overline{x}} {‖ W \cdot [ Y - \overline{σ} ( \overline{x} ) ] ‖}^{p} \qquad ( 2 )$$

Equation (2) may be subject to x̅ₘ̅ᵢ̅ₙ̅≤x̅≤x̅ₘ̅ₐ̅ₓ̅ and other constraints. By way of definition, x̅ₘ̅ᵢ̅ₙ̅=(xₘᵢₙ⁽¹⁾,xₘᵢₙ⁽²⁾, . . . , xₘᵢₙ⁽⁸⁾)^{T}, and x̅ₘ̅ₐ̅ₓ̅=(xₘₐₓ⁽¹⁾,xₘₐₓ⁽²⁾, . . . , xₘₐₓ⁽⁸⁾)^{T}, where xₘₐₓ^{(J)} denotes an upper bound for the physical parameter xⱼ, and xₘᵢₙ^{(j)} denotes a lower bound for xⱼ.

O(x̅) denotes the misfit (error) objective (or cost) function of the constrained optimization problem of Equation (2). By way of definition, O(x̅)=∥W·[Y−σ̅(x̅)]∥^{p}, where Y denotes the measured MCI data expressed as a N-dimensional column vector. σ̅(x̅) denotes the predicted MCI data vector and is computed based on the selected borehole-formation R 1D model. W denotes a data weighting matrix, which is typically a diagonal block matrix. ∥●∥^{p} denotes the norm of a vector, where the power p defines the type of norm that is used. The value of the power p is normally chosen to be equal to 2.

Solving the optimization problem of Equation (2) may involve a direct solution of Maxwell's equations in this model, or it may involve using a lookup table built from such a solution. For example, a lookup table of a response of a tool (e.g., downhole tool 26, logging tool 134) may be built. The lookup table of the tool response may be built (as a forward model) using 2D (two-dimensional), or 3D (three-dimensional) codes, the lookup table including a sufficient range of all eight parameters. In addition, interpolation techniques such as linear or non-linear techniques (e.g., cubic spline, the Akima spline interpolation) may be used to estimate responses that fall between discrete parameters. The predicted data vector is also expressed as an N-dimensional column vector.

Any of various practical iteration optimization techniques (e.g., stochastic or deterministic) may be used to solve the constrained optimization problems described earlier. For example, constrained Newton-based methods can be used for the inversion of all unknown model parameters, as described in Zhdanov, Geophysical inverse problems and regularization theory, 2002.

The iteration process is stopped when any of various conditions are met. For example, a commonly used condition is the root mean square of the relative misfit error reaching a prescribed value η, as expressed in Expression (3) below:

(∥O(x̅)∥^{p})^{1/p}≤η. (3)

The value η may be determined from estimates of noise in the data. For example, η may be a predetermined a priori value that is provided by the user. In a hypothetical case of noise-free data, η=0.

The misfit error is often used to assess the quality of the inverted parameters (e.g., horizontal and vertical resistivities and dip) before such parameters are used for petrophysical interpretation. However, the quality of inverted results may also be dependent on other factors—e.g., the validity of various assumptions (e.g., TI, invasion-free R1D model) that were made, the quality of the R1D inversion library, and/or the MCI sensitivity to different formation parameters. Therefore, a low misfit error does not necessarily guarantee that inverted results (e.g., Rₕ, Rᵥ, dip and dip azimuth) are of sufficiently high quality.

In at least some embodiments, self-consistency quality indicators are used. Such indicators may be used as additional measures of quality.

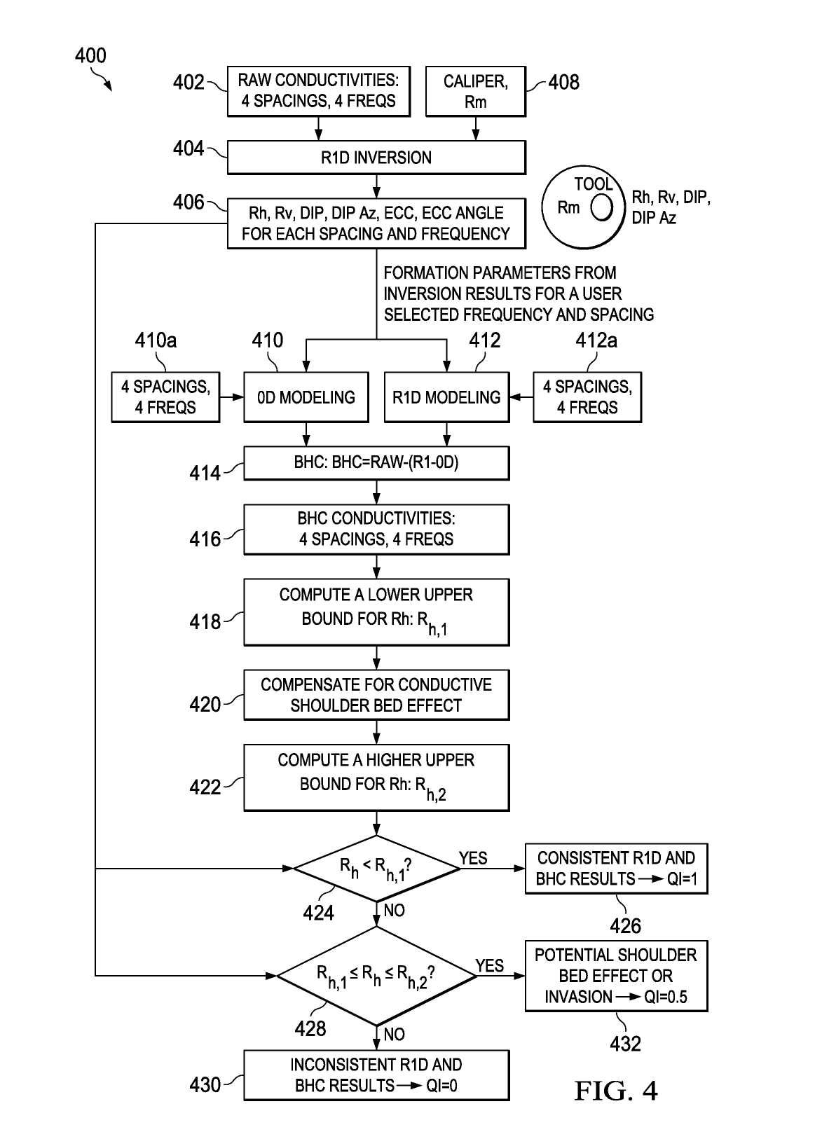

An example of a self-consistency quality indicator will now be described with reference to FIG. 4. FIG. 4 is a flowchart of an illustrative method 400 that uses a quality indicator (QI) according to a least some embodiments. The QI is used to check for consistency R1D based inversion results and borehole correction (BHC) results.

With reference to box 402 of FIG. 4, measurements are obtained from a MCI tool (e.g., downhole tool 26, logging tool 134). For example, when activated, the MCI tool can measure raw conductivities using four frequencies (e.g., by operating a single transmitter at four different frequencies) and four spacings (e.g., four receivers located at different distances from the transmitter). At box 404, an R1D-based inversion is performed. As described earlier, MCI processing uses R1D-based inversion to solve for parameters, including Rₕ, Rᵥ, Dip, Dip azimuth, tool eccentricity and eccentricity angle, for each spacing and frequency in the input dataset (see box 406). When particular parameters (e.g., mud resistivity Rm, and borehole diameter) are known from other independent measurements, these parameters may be used as inputs to the R1D-based inversion (see box 408). R1D inversion may use a pre-computed library of responses to invert input data (raw conductivities) in real-time.

With continued reference to FIG. 4, R1D inversion is followed by BHC processing. BHC is performed to generate apparent conductivity curves that are free from a borehole effect. The effect of the borehole can be estimated by running two different forward models. A first model is a R1D model with borehole (see box 410), and a second model is a zero-dimensional (0D) model (TI homogeneous space) without borehole (see box 412). In both models, formation parameters (e.g., Rₕ, Rᵥ, Dip, Dip azimuth) obtained from R1D inversion are used as inputs. For example, formation parameters corresponding to a selected frequency (from among four different frequencies) and a selected spacing (from among four different spacings) are input to the 0D model (see box 410a). Similarly, formation parameters corresponding to a selected frequency (from among four different frequencies) and a selected spacing (from among four different spacings) are input to the R1D model (see box 412b). The effect of the borehole is determined based on the results of the 0D modeling and the results of the R1D modeling. For example, at box 414, the effect is determined by subtracting the 0D model results from the R1D model results. In this manner, borehole corrected apparent conductivity curves are obtained by subtracting the borehole effect from the raw apparent conductivity curves.

Based on the BHC conductivities, one or more upper bounds for Rₕ are estimated, and Rₕ is compared with those bounds to assess the quality of inverted results. The upper bound(s) are estimated based on formation parameters corresponding to a selected frequency (from among four different frequencies) and a selected spacing (from among four different spacings) (see box 416). According to at least some embodiments, two upper bounds are estimated. A first upper bound (see box 418) is referred to as the lower upper bound and is denoted by R_{h,1}. In one embodiment, R_{h,1} is computed based on Equation (4) below:

$${R}_{h , 1} = \vert \frac{1000}{Czz 12 kHz 17} \vert \qquad ( 4 )$$

The first upper bound is computed based on a zz component (axial component) of a particular array at a particular frequency. For example, with reference to Equation (4), the first upper bound is based on a reciprocal of the apparent conductivity Czz12kHz17, which is the zz component (axial component) of a 17-inch array (the shortest triaxial array in the MCI tool) at a frequency of 12 kHz (the lowest frequency used by the tool). The unit of Czz12kHz17 is mmho/m.

The formulation of Equation (4) will now be explained in more detail. In homogeneous formations, the effective resistivity seen by the zz component is related to the Rₕ, Rᵥ and dip angle α based on the relationship captured in Equation (5) below:

$${R}_{zz} = \frac{λ {R}_{h}}{\sqrt{{sin}^{2} α + {λ}^{2} {cos}^{2} α}} \qquad ( 5 )$$

In Equation (5),

$${λ}^{2} = \frac{{R}_{v}}{{R}_{h}}$$

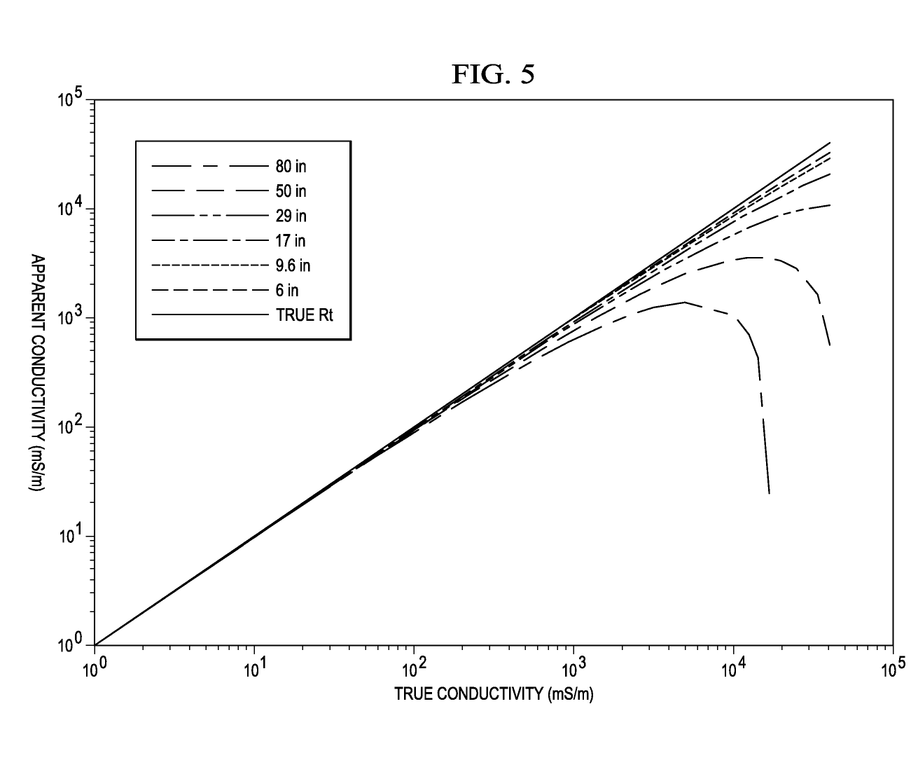

denotes the anisotropy ratio. R_{zz} is always ≥Rₕ (given that Rᵥ is typically ≥Rₕ). On the other hand, each one of the apparent conductivities CzzfreqSpacing is subject to a different level of skin effect depending on the values of the particular frequency and the particular spacing. A plot of the apparent conductivities of different arrays at 12 kHz is shown in FIG. 5, which illustrates the skin effect in different MCI arrays (e.g., conventional 80-inch, 50-inch, 29-inch, 17-inch, 9.6-inch, and 6-inch ZZ subarrays) at a particular frequency (12 kHz). The skin effect makes the apparent conductivity appear lower than the true conductivity, which is also illustrated in FIG. 5. Longer arrays and higher frequencies experience stronger skin effect. Therefore, in homogeneous formations, the reciprocal of CzzfreqSpacing provides an upper bound for Rₕ. The tightest upper bound (corresponding to a configuration that is least affected by skin effect) may be obtained by picking the shortest array and the lowest frequency as expressed in Equation (4).

In layered formations, however, Equation (5) does not necessarily hold true, and the reciprocal of CzzfreqSpacing may be lower than Rₕ. An example of a layered formation may include a higher resistivity layer located between two more conductive layers. Within the higher resistivity layer near the boundaries, the CzzfreqSpacing reading will be affected by the higher conductivity of the adjacent layers. Depending on the resistivity contrast between layers and the relative dip angle, R_{h,1} may fall below Rₕ. This behavior (or phenomenon) is referred to as the conductive shoulder bed effect. Compensation for the conductive shoulder bed effect is performed starting at box 420.

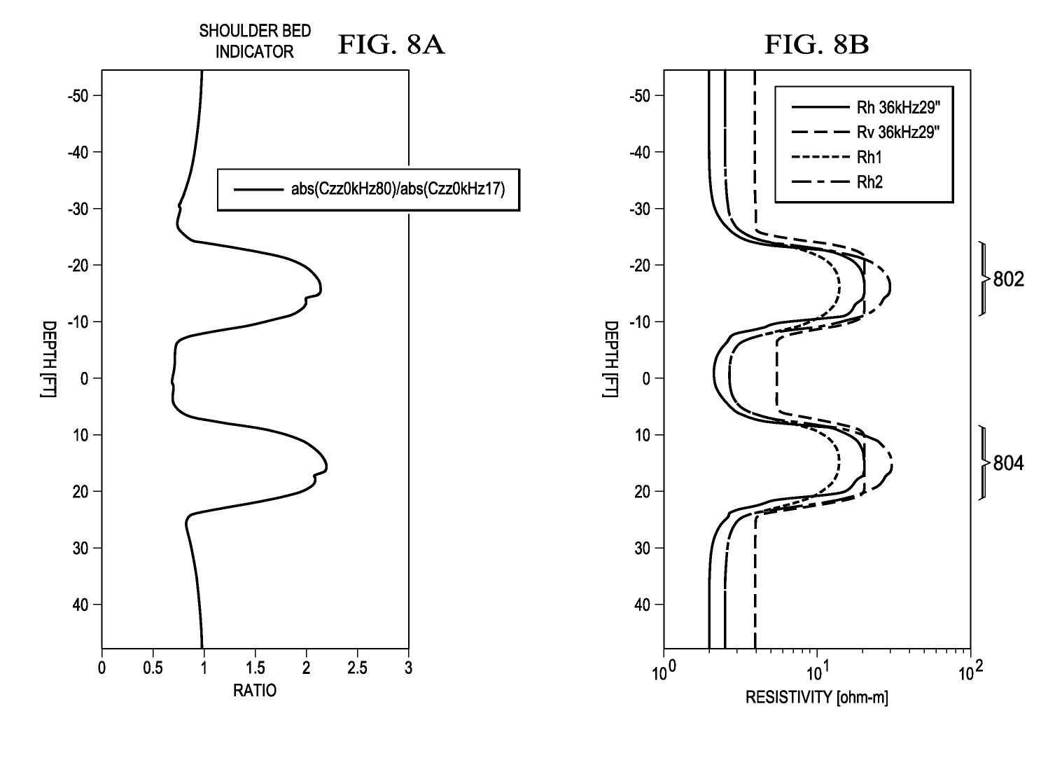

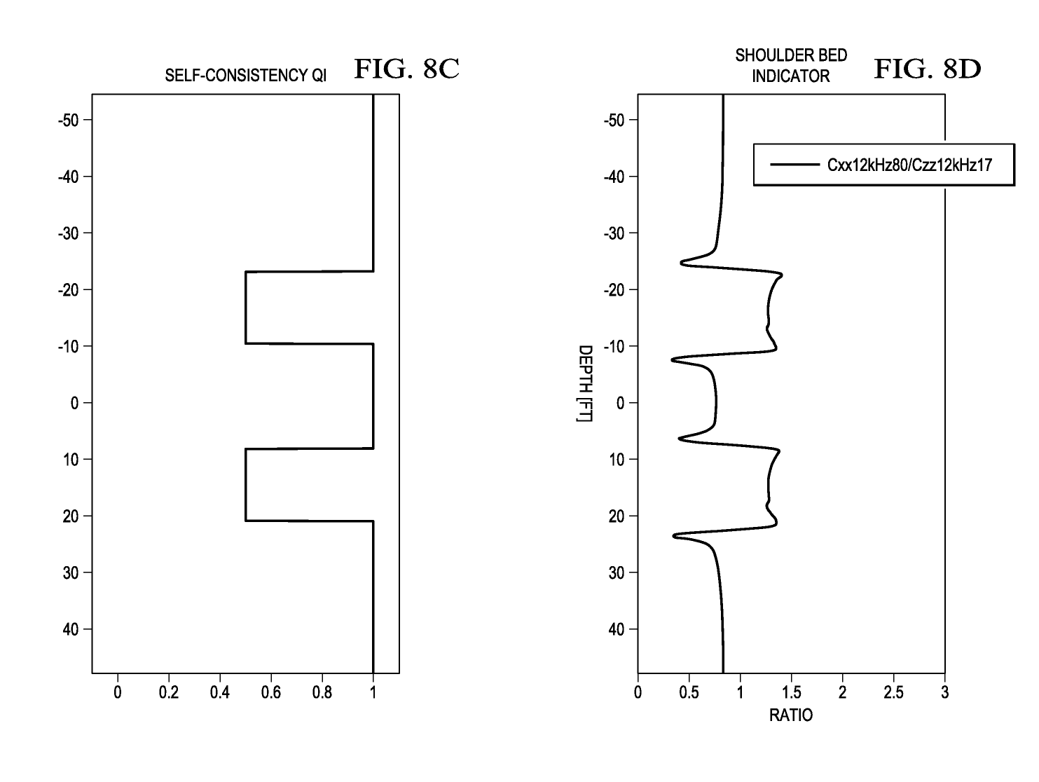

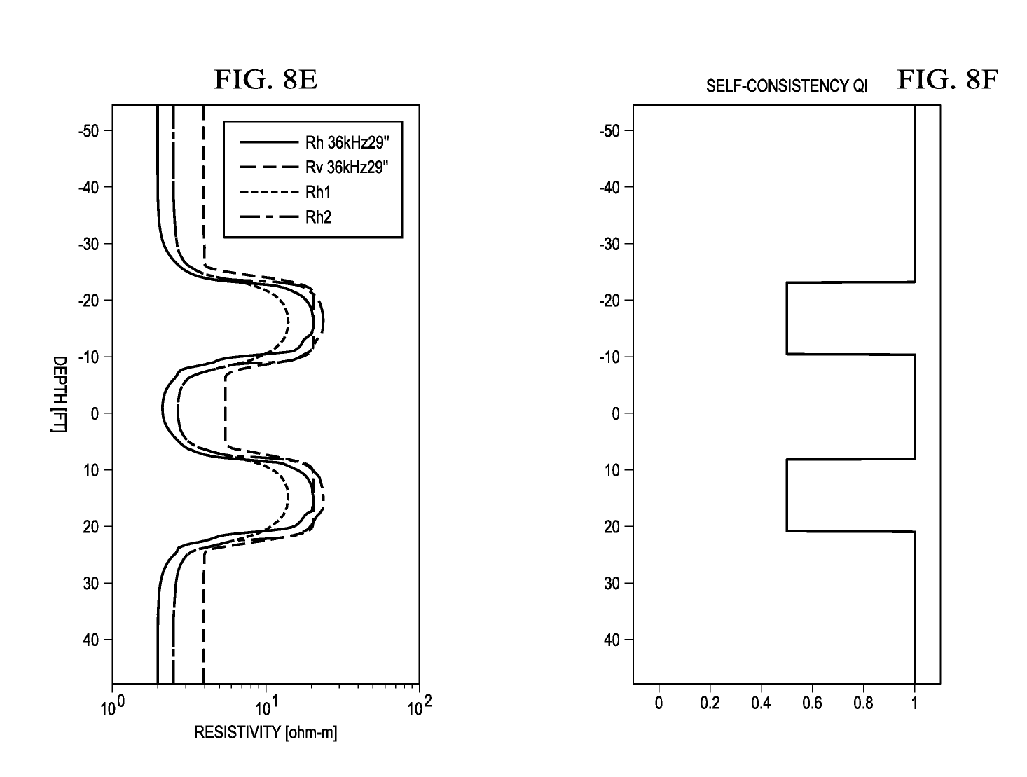

Examples of the conductive shoulder bed effect are illustrated in FIGS. 8A, 8B, 8C, 8D, 8E and 8F, which show that, in higher resistivity layers, R_{h,1} is lower than Rₕ. As illustrated more particularly in the plots of FIGS. 8B and 8E, the shoulder bed effect is less pronounced in the R1D inversion results (Rₕ and Rᵥ) than in the BHC results (e.g., R_{h,1}). This is because R1D inversion uses a combination of raw apparent conductivity curves (e.g., 2Czz-Cxx rather than Czz) as inputs to the inversion, to improve vertical resolution. The plots of FIGS. 8A, 8B, 8C, 8D, 8E and 8F will be described in further detail later.

With reference back to FIG. 4—in at least some embodiments, to assess the quality of R1D inversion in layers affected by the conductive shoulder bed effect, a second upper bound (or higher upper bound) R_{h,2} is estimated (see box 422). R_{h,2}≥R_{h,1} and compensates, at least approximately, for the shoulder bed effect.

The value of Rₕ is then compared against the estimated upper bounds in order to determine the R1D QI. At box 424, Rₕ is compared against the lower upper bound R_{h,1}. If Rₕ<R_{h,1}, then it is determined that Rₕ (from R1D inversion) is consistent with BHC results (see box 426). Further, the value of the QI is set to a value that is indicative of high quality (e.g., 1).

If R_{h,1}≤Rₕ≤R_{h,2}, and the conductive shoulder bed effect is present, then Rₕ may be allowed to exceed R_{h,1} without adversely affecting the value of the QI. In this situation, the QI is set equal to a value indicative of high quality (e.g., 1). However, on the other hand, if the conductive shoulder bed effect is absent, then Rₕ is not allowed to exceed R_{h,1}. In this situation, if Rₕ exceeds R_{h,1}, then the QI is set to a value that is indicative of low quality (e.g., 0) (see boxes 428 and 430).

In some situations, it might not be possible (or feasible) to detect the presence (or absence) of the conductive shoulder bed effect in real-time. Accordingly, in at least some embodiments, if R_{h,1}≤Rₕ≤R_{h,2}, then the value of the QI is set to be smaller than 1 but larger than 0 (e.g., 0.5) (see boxes 428 and 432). Such a value indicates that the R1D inversion quality may not be available in real-time and/or that a conductive shoulder bed effect is potentially present.

With continued reference to FIG. 4, if Rₕ>R_{h,2}, then the difference between Rₕ and R_{h,1} is considered to be too large to be explained by a phenomenon such as the shoulder bed effect. Therefore, it is determined that Rₕ (from R1D inversion) is inconsistent with BHC results (see boxes 428 and 430). Further, the value of the QI is set to a value that is indicative of low quality (e.g., 0).

Compensating for the conductive shoulder bed effect will now be described in more detail with reference to various embodiments.

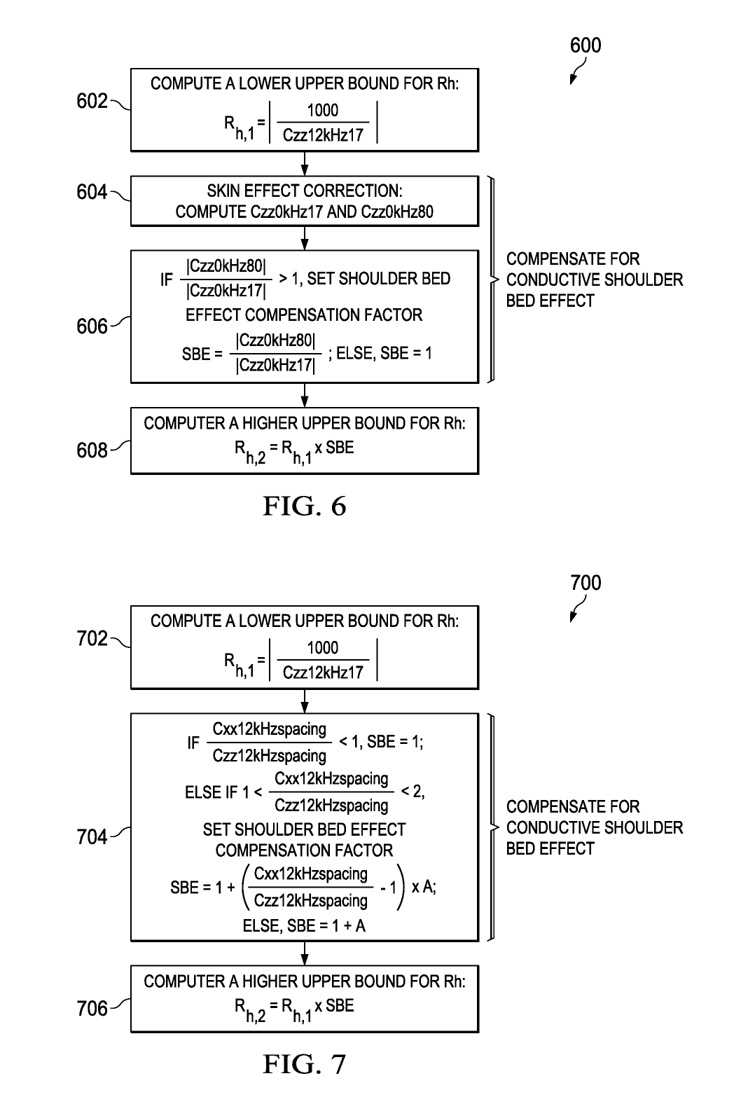

FIG. 6 is a flowchart of an illustrative method 600 for compensating for the conductive shoulder bed effect according to at least some embodiments. According to the method 600 of FIG. 6, R_{h,1} is determined based on Equation (4) (see box 602). In addition, the ratio of the zz conductivities of the longest and shortest arrays is used as an indicator for determining the conductive shoulder bed effect. At box 604, skin effect correction may be applied to decouple the skin effect from the conductive shoulder bed effect. In this regard, the zz conductivity of the shortest array (e.g., Czz0kHz17) and the zz conductivity of the longest array (e.g., Czz0kHz80) are computed, where “0kHz” denotes skin effect corrected conductivities. If a conductivity seen by the longest array is higher that seen by the shortest array, this may indicate the presence of conductive shoulder bed effect, non-conductive invasion, or a combination of both (see box 606). In all cases, a boost factor (or SBE) is computed. The SBE is multiplied by the lower upper bound R_{h,1} to obtain the higher upper bound R_{h,2} (see box 608).

According to at least some embodiments, the SBE is calculated based on Equation (6) below.

SBE=f(Czz0kHz_i, Czz0kHz_j), i≠j (6)

In Equation (6), Czz0kHz_i denotes the skin effect correction zz conductivity measured by subarray i, and f(·) is any appropriate function.

With continued reference to FIG. 6 (see box 606), a condition is determined based on the expression

$$\frac{\vert Czz 0 kHz 80 \vert}{\vert Czz 0 kHz 17 \vert} .$$

This expression is used to determine if a conductivity seen by the longest array is higher that seen by the shortest array.

If the value of the noted expression is greater than 1, then it is determined that the conductivity seen by the longest array is higher that seen by the shortest array. Accordingly, the shoulder bed effect is determined to be present, and the SBE is determined based on Equation (7) below.

$$SBE = \frac{\vert Czz 0 kHz 80 \vert}{\vert Czz 0 kHz 17 \vert} \qquad ( 7 )$$

Otherwise, the value of the SBE is set equal to 1.

At box 608, the SBE is multiplied by the lower upper bound R_{h,1} to obtain the (potentially) higher upper bound R_{h,2}.

FIGS. 8A, 8B and 8C are plots of, respectively, the shoulder bed effect presence indicator according to the method 600 of FIG. 6, the corresponding upper bounds for Rₕ, and corresponding values of the QI. FIG. 8A is a plot of the SBE as determined according to box 606 of FIG. 6. FIG. 8B shows a plot of sample values of the resistivity Rₕ, along with plots of the upper bounds R_{h,1} and R_{h,2}, as determined according to boxes 602 and 608, respectively. FIG. 8C is a plot of the QI, as determined according to the method 400 of FIG. 4.

With reference to FIG. 8B, values of the resistivity Rₕ, fall between the upper bound R_{h,1} and the upper bound R_{h,2} at regions 802 and 804. As such, FIG. 8C shows that the value of the QI is set equal to a lower value (e.g., 0.5) in these situations (see also boxes 428 and 432 of FIG. 4).

According to at least some embodiments, the ratio of the xx conductivity to the zz conductivity for the lowest frequency and a given array is used as an indicator of the presence of a conductive shoulder bed effect in measurements provided by that array.

FIG. 7 is a flowchart of an illustrative method 700 of compensating for the conductive shoulder bed effect according to at least some embodiments. According to the method 700, R_{h,1} is determined based on Equation (4) (see box 702). At box 704, The boost factor SBE may be computed as a linear function of the ratio

$$\frac{Cxx 12 kHz spacing}{Czz 12 kHz spacing} .$$

For example, if the ratio

$$\frac{Cxx 12 kHz spacing}{Czz 12 kHz spacing}$$

is less than 1, then the value of the SBE is set equal to 1. As another example, if the ratio

$$\frac{Cxx 12 kHz spacing}{Czz 12 kHz spacing}$$

is greater than 1 but less than 2, then the SBE is computed as being equal to

$$1 + ( \frac{Cxx 12 kHz spacing}{Czz 12 kHz spacing} - 1 ) \times A .$$

Here, A denotes an amplification factor. According to at least some embodiments, the value of A is chosen to be equal to a value that is between 2 and 3. Otherwise, the SBE is set equal to 1+A.

Similar to box 608 of FIG. 6 at box 706, the SBE is multiplied by the lower upper bound R_{h,1} to obtain the higher upper bound R_{h,2}.

FIGS. 8D, 8E and 8F are plots of, respectively, the shoulder bed effect presence indicator according to the method 700 of FIG. 7, the corresponding upper bounds for Rₕ, and corresponding values of the QI. FIG. 8A is a plot of the SBE as determined according to box 704 of FIG. 7. FIG. 8B shows a plot of sample values of the resistivity Rₕ, along with plots of the upper bounds R_{h,1} and R_{h,2}, as determined according to boxes 702 and 704, respectively. FIG. 8C is a plot of the QI, as determined according to the method 400 of FIG. 4.

With reference to FIG. 8B, values of the resistivity Rₕ, fall between the upper bound R_{h,1} and the upper bound R_{h,2} at regions 806 and 808. As such, FIG. 8C shows that the value of the QI is set equal to a lower value (e.g., 0.5) in these situations (see also boxes 428 and 432 of FIG. 4).

Both FIGS. 8C and 8F show examples of plots of the self-consistency QI based on comparisons of Rₕ (from R1D inversion) with 2 upper bounds for Rₕ that are estimated based on BHC results. In these examples, a 5-layer synthetic log is used. The value of the Dip is 50 degrees, and the value of the dip azimuth is 70 degrees.

The cause of an indication of low quality at any given depth may be investigated. According to at least some embodiments, the cause is investigated by analyzing QIs corresponding to highly dipped resistive layers (or fractures), biaxial anisotropy and/or invasion. Biaxial anisotropy refers to a situation in which the resistivities Rₓ and R_{y} in directions x and y, respectively, are not equal to each other.

A real-time indicator for thin resistive layers with high relative dip may be calculated from the BHC conductivities of any given frequency/spacing combination. Such layers could represent fractures intercepting the borehole. The presence of such highly dipped resistive layers tends to increase the xx and yy conductivities, and to decrease the zz conductivity. An example of a QI that relates to this cause is determined based on Equation (8) below.

$$QI high dip = \frac{Czz 12 kHz 80 - \frac{Cxx 12 kHz 80 + Cyy 12 kHz 80}{2}}{max \{ \begin{matrix}Czz 12 kHz 80 , Czz 12 kHz 80 - \\ \frac{Cxx 12 kHz 80 + Cyy 12 kHz 80}{2}\end{matrix} \}} \qquad ( 8 )$$

Based on Equation (8), if

$$\frac{Cxx 12 kHz 80 + Cyy 12 kHz 80}{2} << Cz z 12 kHz 80 ,$$

then QI high dip→1.

However, if

$$\frac{Cxx 12 kHz 80 + Cyy 12 kHz 80}{2} \geq Czz 12 kHz 80 ,$$

then QI high dip=0.

A real-time indicator for biaxial anisotropy may be calculated from the BHC conductivities of any given frequency/spacing combination, rotated to zero dip azimuth. An example of a QI that relates to this cause is determined based on Equation (9) below.

$$QI BA = 1 - \frac{\vert Cxx 12 kHz 80 \_ 0 DipAzi - Cyy 12 kHz 80 \_ 0 DipAzi \vert}{max \{ \begin{matrix}\vert Czz 12 kHz 80 \vert , \\ \vert \begin{matrix}Cxx 12 kHz 80 \_ 0 DipAzi - \\ Cyy 12 kHz 80 \_ 0 DipAzi\end{matrix} \vert\end{matrix} \}} \qquad ( 9 )$$

Based on Equation (9), if |Cxx12kHz80_0DipAzi−Cyy12kHz80_0DipAzi|<<|Czz12kHz80|, then QI BA→1.

However, if |Cxx12kHz80_0DipAzi−Cyy12kHz80_0DipAzi|≥|Czz12kHz80|, then QI BA=0. Biaxial anisotropy could be caused by fractures either intercepting the borehole or intercepting a nearby formation. It is noted that highly dipped TI layers may give rise to a BA-like effect.

A real-time indicator for invasion may be calculated by comparing the axial component of BHC conductivities of different subarrays. According to at least some embodiments, a QI for invasion is determined based on Equation (10) below. If invasion is absent, then the value of the QI Invasion should be equal to 1 (QI Invasion=1). Otherwise, the value of the QI Invasion should be less than 1 (QI Invasion<1).

$$QI Invasion = 1 - \frac{\vert Czz 0 Hz 17 - Czz 0 Hz 80 \vert}{max \{ \begin{matrix}Czz 0 Hz 17 , Czz 0 Hz 80 , \\ \vert Czz 0 Hz 17 - Czz 0 Hz 80 \vert\end{matrix} \}} \qquad ( 10 )$$

Based on Equation (10), if |Czz0Hz17−Czz0Hz80|<<max{Czz0Hz17, Czz0Hz80}, then QI Invasion→1.

However, if |Czz0Hz17−Czz0Hz80|≥max{Czz0Hz17, Czz0Hz80}, then QI Invasion=0.

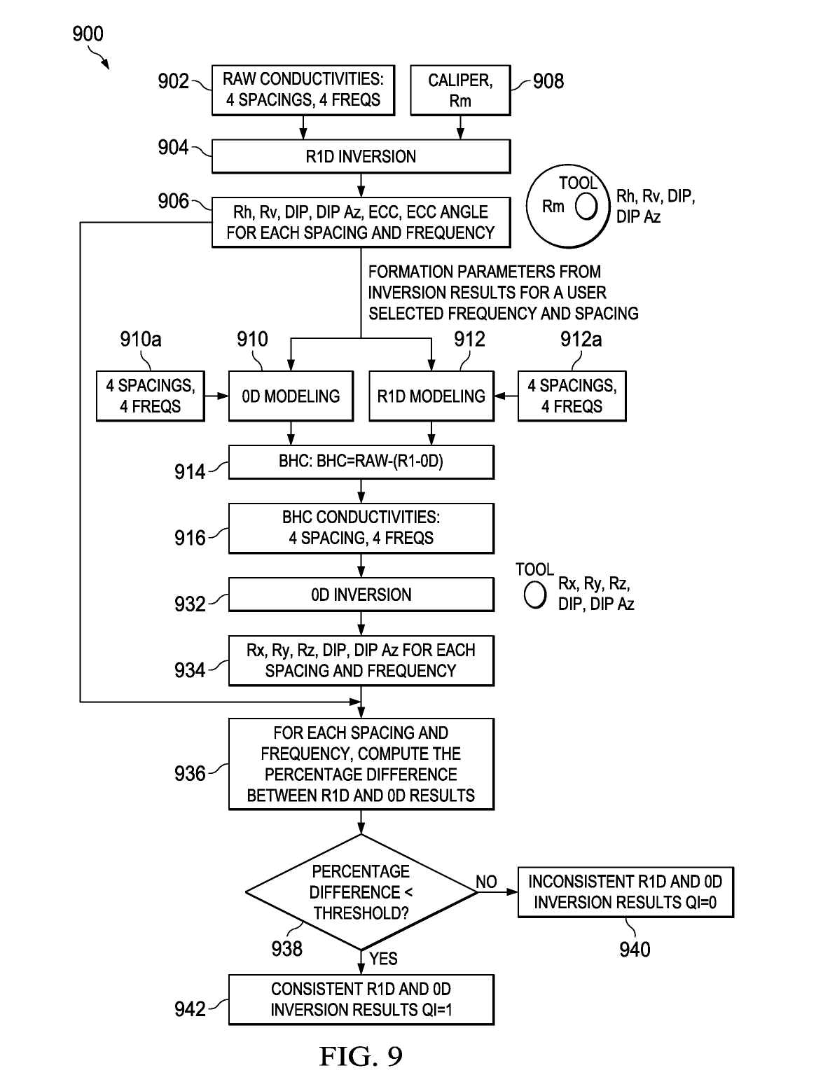

FIG. 9 is a flowchart of an illustrative method 900 that uses a quality indicator to check for consistency between R1D and 0D inversion results according to at least some embodiments.

The method 900 of FIG. 9 is similar to the method 400 of FIG. 4 in several aspects. For example, as described earlier with reference to FIG. 4, standard MCI processing uses an R1D-based inversion to solve for Rₕ, Rᵥ, Dip, Dip azimuth, tool eccentricity and eccentricity angle for each subarray and frequency in the input dataset (see boxes 902, 904, 908, 906, 908). Mud resistivity and borehole diameter may often be known from other independent measurement(s), and inputted to the R1D-based inversion. R1D inversion uses a pre-computed library of responses to invert the data in real-time (see boxes 910a, 910, 912a, 912).

As another example, similar to the method 400 of FIG. 4, borehole corrected apparent conductivity curves are obtained by subtracting the borehole effect from the raw apparent conductivity curves (see box 912).

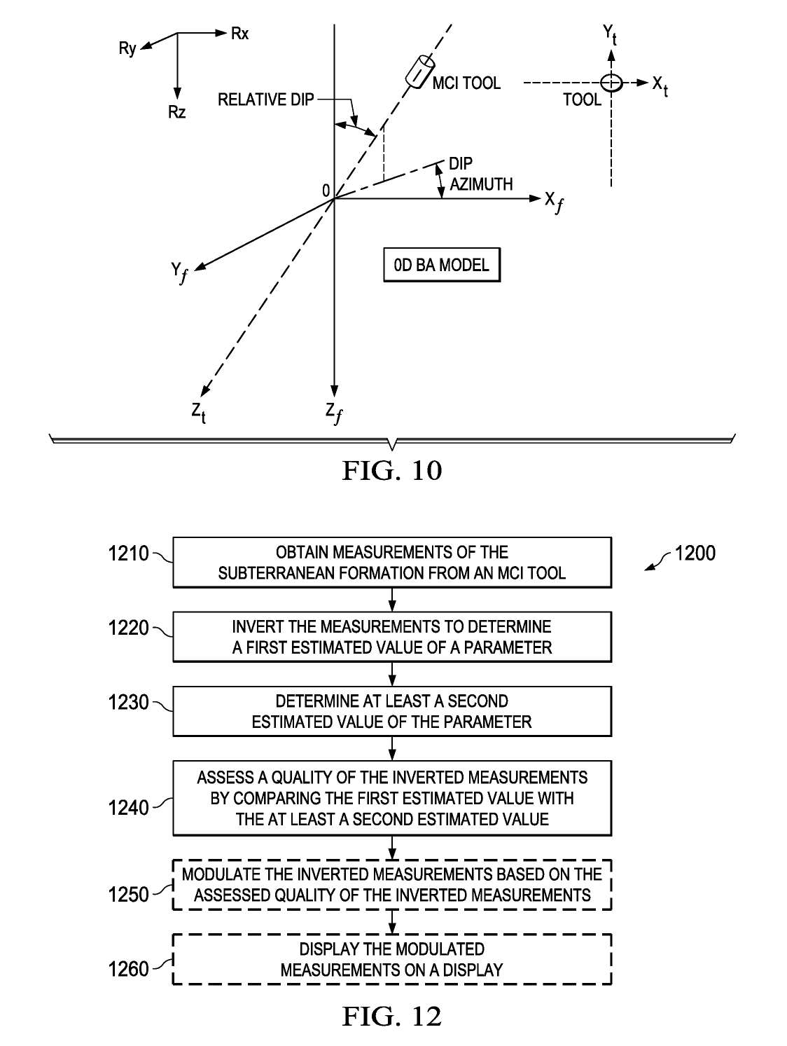

Select differences between the method of FIG. 9 and that of FIG. 4 will now be described in more detail. After the borehole corrected apparent conductivity curves are obtained, another type of real-time processing is performed. According to at least some embodiments, this other type of processing is an 0D-based inversion with biaxial anisotropy (BA) (see box 932). This type of inversion is based on a semi-analytical forward model for homogeneous formations with biaxial anisotropy (see, e.g., FIG. 10). At box 916, measurements are obtained from a MCI tool (e.g., downhole tool 26, logging tool 134). For example, the MCI tool measures raw conductivities using four frequencies (e.g., by operating a single transmitter at four different frequencies) and four spacings (e.g., four receivers located at different distances from the transmitter). The semi-analytical forward model may be computed with sufficiently high speed for real-time processing. Model parameters that may be solved for by the 0D inversion with BA include Rₓ, R_{y}, R_{z}, Dip, and Dip azimuth (see box 934).

To check for consistency between results of both inversions (the 0D inversion, and the R1D-based inversion noted earlier), the percentage difference (or error) with respect to one or more model parameters is computed (see box 936). According to at least some embodiments, the percentage difference is computed based on Equation (11) below.

$$D = \frac{1}{2} \times \{ \frac{\vert Rx - Rh \vert}{Rh} + \frac{\vert Ry - Rh \vert}{Rh} \} \times 100 \qquad ( 11 )$$

The percentage difference may also be extended to include other model parameters such as Rᵥ, dip and dip azimuth.

According to at least some embodiments, the percentage difference is compared against a particular threshold (see box 938). For example, a percentage difference that is below a pre-defined threshold (e.g., 5%) indicates consistency between R1D and 0D results. In this situation, the TI assumption that was made in the R1D model is determined to be valid. The R1D inversion quality indicator is therefore set to a value that is indicative of high quality (e.g., 1) (see box 942). In contrast, a percentage difference that is above the threshold may indicate that the TI assumption made in the R1D model is not valid. The R1D inversion quality indicator is therefore set to a value that is indicative of low quality (e.g., 0) (see box 940). According to other embodiments, the QI is set to any value between 0 and 1 based on the difference defined in Equation (11).

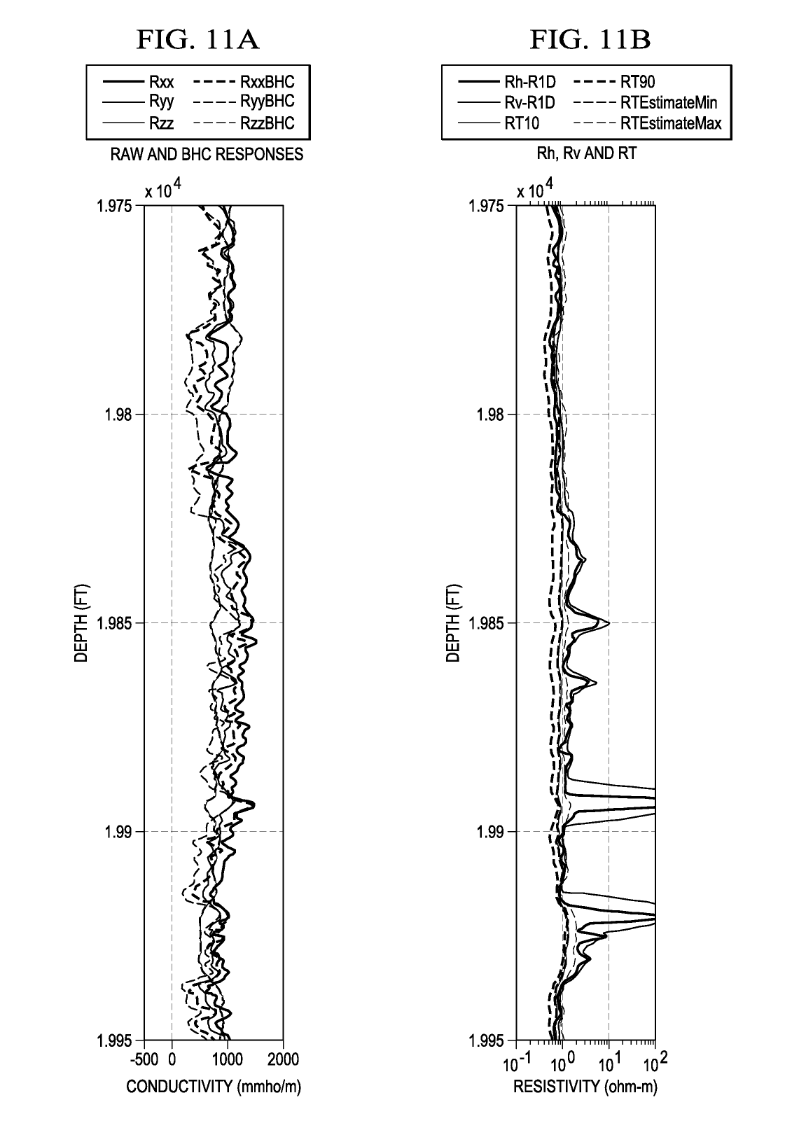

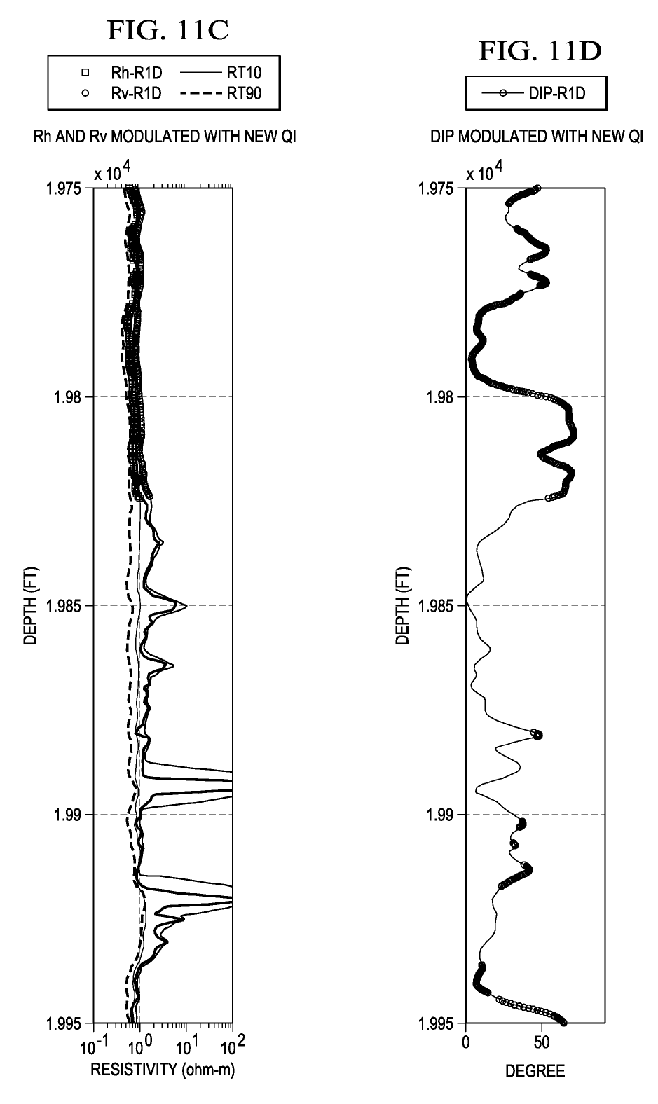

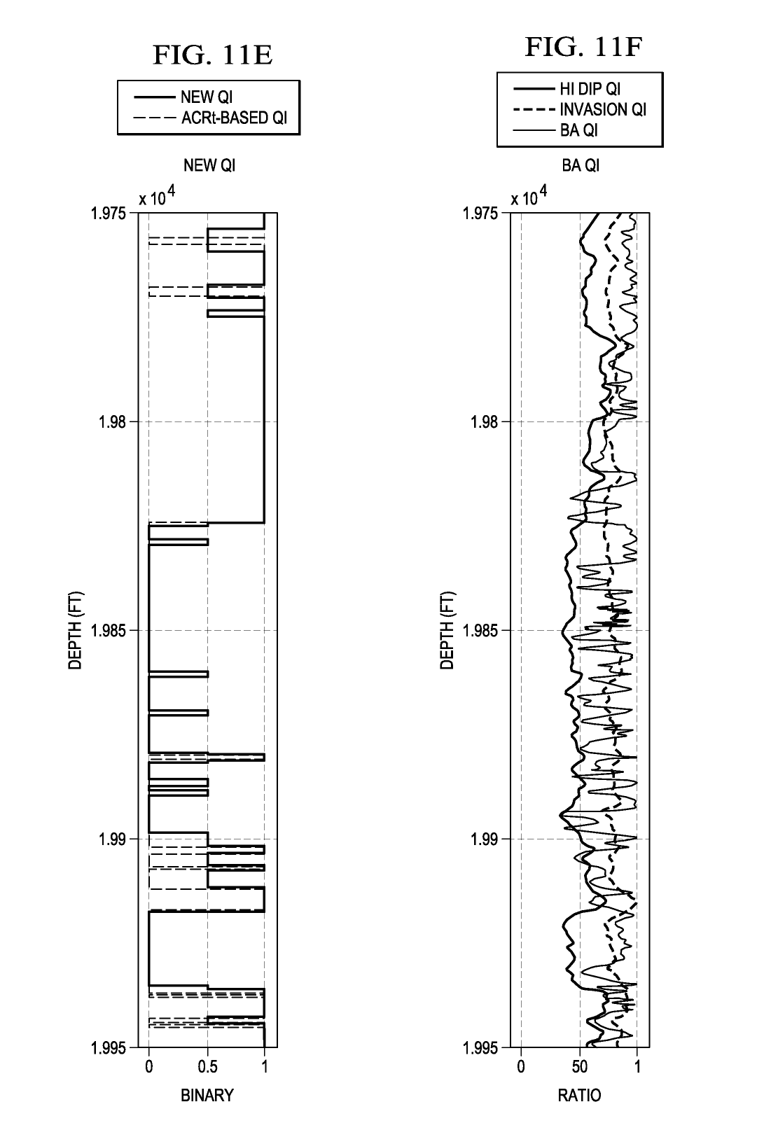

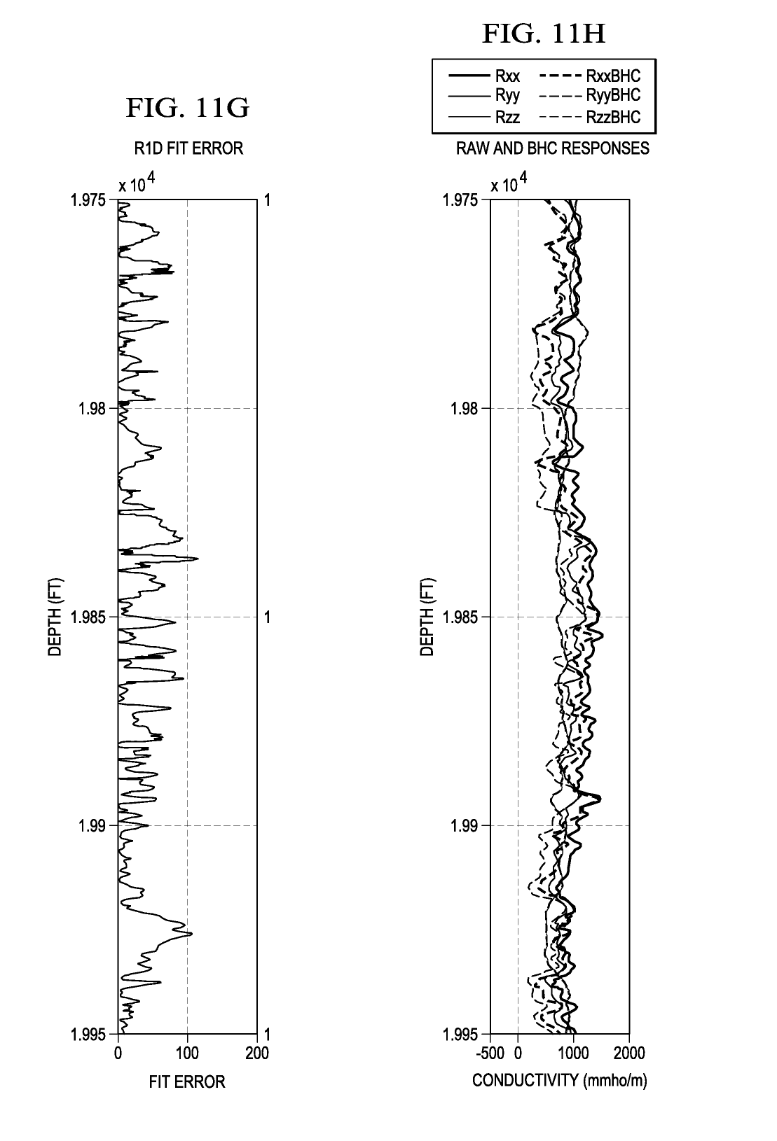

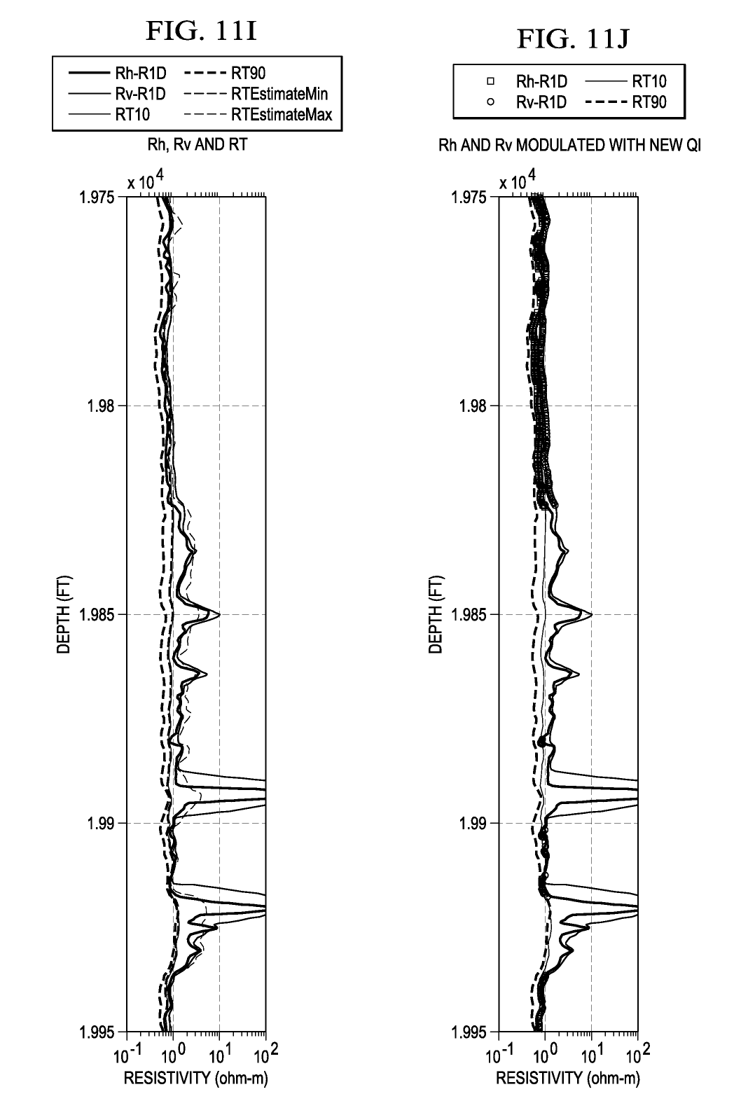

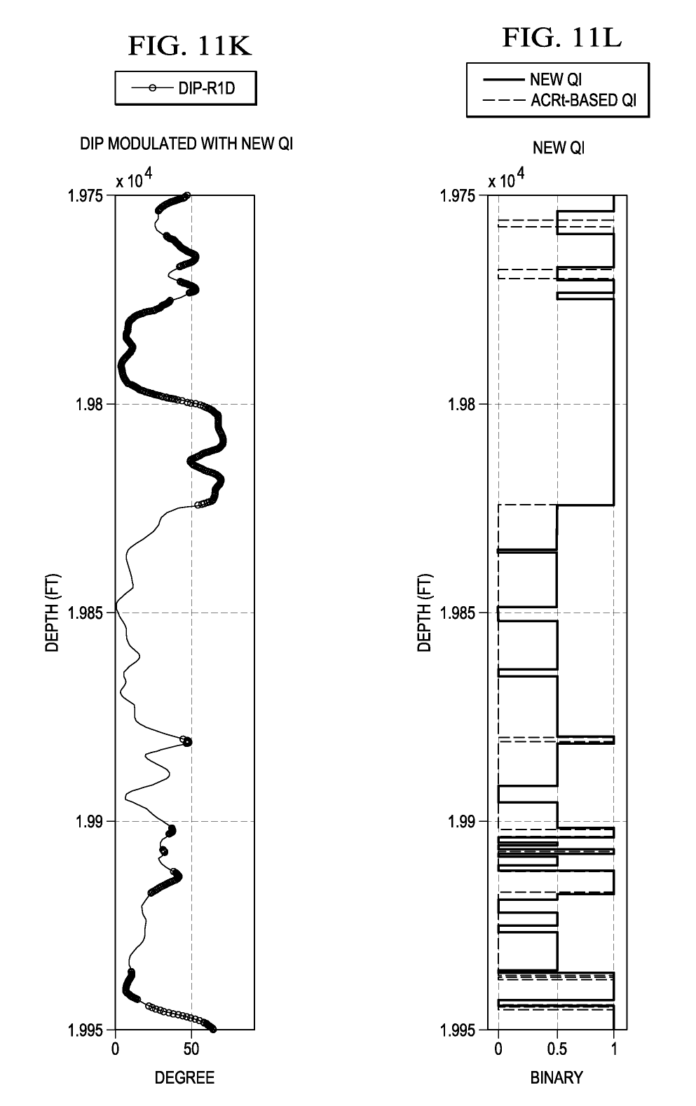

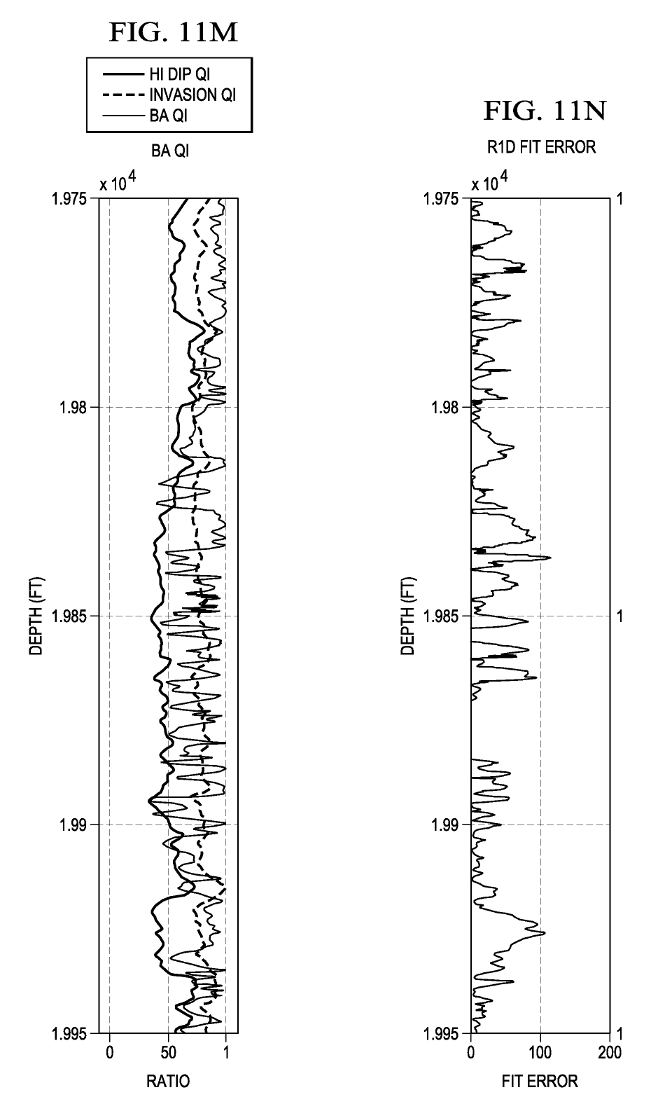

FIGS. 11A to 11N show examples of the application of quality indicators described earlier with reference to various embodiments. These examples are based on field data from an oil-based mud (OBM) well in the Gulf of Mexico (GOM). FIGS. 11A, 11B, 11C, 11D, 11E, 11F and 11G correspond to a quality indicator determined according to the method 600 of FIG. 6, and FIGS. 11H, 11I, 11J, 11K, 11L, 11M and 11N correspond to a quality indicator determined according to the method 700 of FIG. 7. 36 kHz 29-inches array data is used in these examples. FIGS. 11A and 11H show plots of raw and borehole corrected conductivities Cxx, Cyy and Czz. FIGS. 11B and 11I show plots of Rₕ and Rᵥ from MCI R1D inversion, RT10 and RT90 from ACRt processing, and the lower and upper bounds R_{h,1} and R_{h,2}.

ACRt logs are shown for validating the performance of the new quality indicators. ACRt processing uses axial components of the conductivity matrices (zz components) for different arrays and different frequencies to compute the effective formation resistivity as seen by the components at different depths of investigation (DoI). After skin effect and borehole corrections, ACRt uses a type of processing known as software focusing to compute radially focused resistivity logs having different depths of investigation (e.g., the shallowest log has DoI=10″, and the deepest log has DoI=90″). Vertical resolution matching is applied to radially focused logs to compute radially focused logs with matched vertical resolutions of 1 ft (0.30 m), 2 ft (0.61 m) and 4 ft (1.22 m). In FIGS. 11B, 11C, 11I and 11J, RT10 refers to the ACRt resistivity log with DoI=10″ and vertical resolution=2 ft (0.61 m). Similarly, RT90 refers to the ACRt resistivity log with DoI=90″ and vertical resolution=2 ft (0.61 m). In homogeneous formations, RT90 will read the closest value to formation resistivity given in Equation (5).

As shown in FIGS. 11A to 11N, the bounds determined according to various embodiments disclosed earlier provide suitably good upper estimates for the max{RT10,RT90}. Therefore, those bounds serve as good metrics for assessing the quality of Rₕ. FIGS. 11E and 11L show plots of the QI determined according to various embodiments disclosed earlier. Portions of the plots where the QI indicates low (or lower) quality are associated with Rₕ exhibiting non-physical spiking behavior. Those sections might be associated with high resistivity layers with high dip angles exceeding the limit of the R1D inversion database, high dip fractures, and/or highly invaded zones. A reference QI based on max{RT10,RT90} from ACRt is also plotted in FIGS. 11E and 11L to assess or validate the performance of the QIs. Very good agreement between the QIs and the reference QI is illustrated.

FIGS. 11F and 11M show plots of the QIs for biaxial anisotropy (BA) and invasion. Sections with QI indicating low quality seem to be associated with BA, as indicated by the BA QI.

The inversion misfit is shown in the plots of FIGS. 11G and 11N for comparison. In general, sections with QI indicating low quality are associated with relatively higher misfit. However, by looking at the misfit log alone, it may be difficult to identify problematic sections. Methods disclosed earlier with reference to various embodiments use a quality indicator (e.g., a binary quality indicator) to more clearly indicate points in the log that are associated with non-physical inversion results (e.g., those with Rₕ higher than R_{h,2} and the ACRt logs). Such indicators can be more easily interpreted by logging engineers in the field.

Various embodiments disclosed herein rely only (or primarily) on data acquired by the MCI tool. For example, these embodiments do not rely on multi-sensor log data (e.g., data from different logging tools such as other resistivity tools, multi-arm calipers, borehole imagers, LWD, etc.). According to at least some embodiments, point-by-point quality indicators for MCI R1D inversion results are provided in real-time by checking the self-consistency of different types of MCI real-time processing (e.g., R1D, BHC, and 0D with BA). Points in the log associated with non-physical inversion results are more clearly indicated using a binary quality indicator that can be more easily interpreted by logging engineers in the field.

Quality indicators that have been disclosed with reference to various embodiments may be used to modulate inversion results in real-time to visualize the level of confidence in the inversion results. This is shown, for example, in FIGS. 11C, 11D, 11J and 11K, where only points with QI=1 are highlighted.

FIG. 12 is a flowchart of an illustrative method 1200 of processing inversion results corresponding to a plurality of parameters of a subterranean formation, according to at least one embodiment. At box 1210, measurements of the subterranean formation are obtained from an MCI tool (e.g., downhole tool 26, logging tool 134).

At box 1220, the measurements are inverted to determine a first estimated value of a parameter. For example, according to at least one embodiment, the parameter is a horizontal resistivity of the subterranean formation. Also for example, according to at least one embodiment, inverting the measurements includes performing an R1D based inversion.

At box 1230, at least a second estimated value of the parameter is determined. For example, according to at least one embodiment, determining the second estimated value includes performing a borehole correction based on the measurements (see, e.g., box 414 of

FIG. 4, box 914 of FIG. 9). If the parameter is a horizontal resistivity of the subterranean formation, determining the second estimated value may include determining a first upper bound regarding the horizontal resistivity.

At box 1240, a quality of the inverted measurements is assessed by comparing the first estimated value with the at least a second estimated value. For example, as described earlier with reference to box 424 of FIG. 4, Rₕ is compared against the upper bound R_{h,1}. If Rₕ<R_{h,1}, then it is determined that Rₕ (from R1D inversion) is consistent with BHC results (see box 426). Further, the value of the QI is set to a value that is indicative of high quality (e.g., 1).

At box 1250, the inverted measurements may be modulated based on the assessed quality of the inverted measurements (see, e.g., FIGS. 11C, 11D, 11J and 11K). At box 1260, the modulated measurements on a display (e.g., computer monitor 44).

Embodiments disclosed herein include:

A: A related system for logging a subterranean formation includes an MCI tool disposed in a borehole formed in the subterranean formation and a processor coupled to the MCI tool, to obtain measurements of the subterranean formation from an MCI tool, and invert the measurements to determine a first estimated value of a parameter of the plurality of parameters. The processor further determines at least a second estimated value of the parameter, and assesses a quality of the inverted measurements by comparing the first estimated value with the at least a second estimated value.

B: A method that includes obtaining measurements of the subterranean formation from an MCI tool, and inverting the measurements to determine a first estimated value of a parameter of the plurality of parameters. The method further includes determining at least a second estimated value of the parameter, and assessing a quality of the inverted measurements by comparing the first estimated value with the at least a second estimated value.

Each of the embodiments, A and B, may have one or more of the following additional elements in any combination. Element 1: wherein: the processor inverts the measurements by performing an R1D based inversion; and the processor determines the at least a second estimated value by performing a borehole correction based on the measurements. Element 2: wherein the processor assesses the quality of the inverted measurements by assessing whether the quality is adversely affected by at least one of a plurality of geophysical factors, the plurality of geophysical factors including a presence of at least one fracture, a presence of biaxial anisotropic conditions, and a presence of a fluid invasion in the subterranean formation

Element 3: wherein inverting the measurements includes performing an R1D based inversion. Element 4: wherein determining the at least a second estimated value includes performing a borehole correction based on the measurements. Element 5: wherein the parameter is a horizontal resistivity of the subterranean formation. Element 6: wherein determining the at least a second estimated value includes determining a first upper bound regarding the horizontal resistivity. Element 7: wherein the first upper bound is based on a reciprocal of a zz component of a borehole corrected apparent conductivity measured by a shortest triaxial array of the MCI tool at a lowest frequency. Element 8: wherein determining the at least a second estimated value further includes determining a second upper bound regarding the horizontal resistivity, the second upper bound being higher than the first upper bound. Element 9: wherein the second upper bound is determined by multiplying the first upper bound by a boost factor relating to a conductive shoulder bed effect. Element 10: wherein the boost factor is proportional to a ratio of a zz component of a borehole corrected apparent conductivity measured by a longest triaxial array of the MCI tool and a zz component of a borehole corrected apparent conductivity measured by shortest triaxial array of the MCI tool. Element 11: wherein the zz component of the borehole corrected apparent conductivity measured by the longest triaxial array and the zz component of the borehole corrected apparent conductivity measured by the shortest triaxial array are corrected to account for a skin effect. Element 12: wherein the boost factor is proportional to a ratio of an xx component of a borehole corrected apparent conductivity measured by an array of the MCI tool and a zz component of the borehole corrected apparent conductivity. Element 13: wherein determining the second estimated value includes performing a 0-dimensional (0D) based inversion with biaxial anisotropy. Element 14: wherein the quality of the inverted measurements is assessed using a binary indicator. Element 15: further including: modulating the inverted measurements based on the assessed quality of the inverted measurements; and displaying the modulated measurements on a display. Element 16: wherein the quality of the inverted measurements is assessed in real-time. Element 17: wherein assessing the quality of the inverted measurements further includes assessing whether the quality is adversely affected by at least one of a plurality of geophysical factors.

Element 18: wherein the plurality of geophysical factors includes a presence of at least one fracture, a presence of biaxial anisotropic conditions, and a presence of a fluid invasion in the subterranean formation. Element 19: further including: disposing the MCI tool into a borehole formed in the subterranean formation; and activating the MCI tool to take one or more conductivity measurements of the subterranean formation to provide the measurements of the subterranean formation.

Numerous variations and modifications will become apparent to those skilled in the art once the above disclosure is fully appreciated. The methods and systems can be used for assessing the quality of inverted parameters that are based on measurements by an MCI tool. However, it is understood that the disclosed methods and systems can be used for assessing the quality of other types of parameters. The ensuing claims are intended to cover such variations where applicable.

1. A method of processing inversion results corresponding to a plurality of parameters of a subterranean formation, the method comprising:
obtaining measurements of the subterranean formation from a multi-component induction (MCI) tool;
inverting the measurements to determine a first estimated value of a parameter of the plurality of parameters;
determining at least a second estimated value of the parameter; and
assessing a quality of the inverted measurements by comparing the first estimated value with the at least a second estimated value.

2. The method of claim 1, wherein inverting the measurements comprises performing a radial 1-dimensional (R1D) based inversion.

3. The method of claim 2, wherein determining the at least a second estimated value comprises performing a borehole correction based on the measurements.

4. The method of claim 3, wherein the parameter is a horizontal resistivity of the subterranean formation.

5. The method of claim 4, wherein determining the at least a second estimated value comprises determining a first upper bound regarding the horizontal resistivity.

6. The method of claim 5, wherein the first upper bound is based on a reciprocal of a zz component of a borehole corrected apparent conductivity measured by a shortest triaxial array of the MCI tool at a lowest frequency.

7. The method of claim 5, wherein determining the at least a second estimated value further comprises determining a second upper bound regarding the horizontal resistivity, the second upper bound being higher than the first upper bound, wherein the second upper bound is determined by multiplying the first upper bound by a boost factor relating to a conductive shoulder bed effect.

8. (canceled)

9. The method of claim 7, wherein the boost factor is proportional to a ratio of a zz component of a borehole corrected apparent conductivity measured by a longest triaxial array of the MCI tool and a zz component of a borehole corrected apparent conductivity measured by shortest triaxial array of the MCI tool.

10. The method of claim 9, wherein the zz component of the borehole corrected apparent conductivity measured by the longest triaxial array and the zz component of the borehole corrected apparent conductivity measured by the shortest triaxial array are corrected to account for a skin effect.

11. The method of claim 7, wherein the boost factor is proportional to a ratio of an xx component of a borehole corrected apparent conductivity measured by an array of the MCI tool and a zz component of the borehole corrected apparent conductivity.

12. The method of claim 2, wherein determining the second estimated value comprises performing a 0-dimensional (0D) based inversion with biaxial anisotropy.

13. The method of claim 1, wherein the quality of the inverted measurements is assessed using a binary indicator.

14. The method of claim 1, further comprising:
modulating the inverted measurements based on the assessed quality of the inverted measurements; and
displaying the modulated measurements on a display.

15. The method of claim 1, wherein the quality of the inverted measurements is assessed in real-time.

16. The method of claim 1, wherein assessing the quality of the inverted measurements further comprises assessing whether the quality is adversely affected by at least one of a plurality of geophysical factors.

17. The method of claim 16, wherein the plurality of geophysical factors comprises a presence of at least one fracture, a presence of biaxial anisotropic conditions, and a presence of a fluid invasion in the subterranean formation.

18. The method of claim 1, further comprising:
disposing the MCI tool into a borehole formed in the subterranean formation; and
activating the MCI tool to take one or more conductivity measurements of the subterranean formation to provide the measurements of the subterranean formation.

19. A system for logging a subterranean formation, the system comprising:
a multi-component induction (MCI) tool disposed in a borehole formed in the subterranean formation; and
a processor coupled to the MCI tool to:
obtain measurements of the subterranean formation from the MCI tool;
invert the measurements to determine a first estimated value of a parameter of the plurality of parameters;
determine at least a second estimated value of the parameter; and
assess a quality of the inverted measurements by comparing the first estimated value with the at least a second estimated value.

20. The system of claim 19, wherein:
the processor inverts the measurements by performing a radial 1-dimensional (R1D) based inversion; and
the processor determines the at least a second estimated value by performing a borehole correction based on the measurements.

21. The system of claim 19, wherein the processor assesses the quality of the inverted measurements by assessing whether the quality is adversely affected by at least one of a plurality of geophysical factors, the plurality of geophysical factors comprising a presence of at least one fracture, a presence of biaxial anisotropic conditions, and a presence of a fluid invasion in the subterranean formation.
